(19) United States
(12) Patent Application Publication
(10) Pub. No.: US 2005/0024057 A1
(43) Pub. Date: Feb. 3, 2005

(54) Methods of using measured time resolved photon emission data and simulated time resolved photon emission data for fault localization

(76) Inventors: Romain Desplats, Toulouse (FR); Philippe Perdu, Toulouse (FR); Ketan Shah, Cupertino, CA (US); Martin Leibowitz, Fremont, CA (US); Theodore R. Lundquist, Milpitas, CA (US)

Correspondence Address: WAGNER, MURABITO & HAO, LLP, TWO NORTH MARKET STREET, THIRD FLOOR, SAN JOSE, CA, 95113, US

(21) Appl. No.: 10/871,629

(22) Filed: Jun. 17, 2004

Related U.S. Application Data
(60) Provisional application No. 60/480,184, filed on Jun. 20, 2003.

(51) Int. Cl. G01V 3/08

(52) U.S. Cl. 324/334

(57) ABSTRACT

Methods for using measured time resolved photon emission data and simulated time resolved photon emission data for fault localization are provided and described. In one embodiment, a method of localizing a fault in a circuit includes generating simulation photon emission data for the circuit. Moreover, measured photon emission data for the circuit is generated. The simulation photon emission data is compared with the measured photon emission data to generate a comparison result. Further, the comparison result is classified according to predetermined criteria. The classified comparison result is used in a fault localization technique to determine next action in localizing the fault.

### CROSS REFERENCE TO RELATED APPLICATION

This patent application claims the benefit of copending U.S. Provisional Patent Application, Ser. No. 60/480184, filed Jun. 20, 2003, entitled “FAULT LOCALIZATION USING TIME RESOLVED PHOTON EMISSION AND SIMULATED WAVEFORMS,” by Desplats et al.

### BACKGROUND OF THE INVENTION

1. Field of the Invention

The present invention generally relates to fault localization. More particularly, the present invention relates to the field of using measured time resolved photon emission data and simulated time resolved photon emission data for fault localization.

2. Related Art

When a device (e.g., an electronic device, an integrated circuit chip, etc.) is not operating correctly, a tester (e.g., automated test equipment (ATE)) can identify faults due to a wide range of sources (e.g., short circuits). To use a tester's capabilities to investigate defects, the minimum information required is a test sequence, which places the device in a failed mode and, therefore, the circuit in question in a failed mode. If the defect is more subtle, other solutions such as software based fault isolation may be used. With fault dictionaries and simulations, a greater range of defects may be covered but significant CPU time is required. When software diagnosis is insufficient (e.g., an incomplete fault model), fault isolation then requires the use of probes. Internal probing of a device can establish a measurement at specific nodes yielding valuable information concerning the actual behavior of a circuit, both analog and digital. Existing techniques include: contact micro-probing, photon emission microscopy (PEM), electron beam probing, laser voltage probing and optical time resolved probing (e.g., time resolved photon emission (TRPE) and picoseconds imaging circuit analysis (PICA)). This latter technique makes it possible to measure precise optical waveforms through the backside silicon in order to obtain timing (e.g., signal delay) information.

To locate defects using these internal measurements, each waveform obtained must be compared with a known reference. This comparative approach works between two circuits (one good, one failed) or with regards to simulated signals. If simulation is used to obtain reference signals, the question that arises is “How to compare time resolved photo emission (TRPE) waveforms (linked with current) to logic state waveforms (linked with voltage)?”

### SUMMARY OF THE INVENTION

Methods for using measured time resolved photon emission data and simulated time resolved photon emission data for fault localization are provided and described. In one embodiment, a method of localizing a fault in a circuit includes generating simulation data based on logical states of the circuit at predetermined intervals. Moreover, the simulation data is converted into simulation photon emission data based on photon emission intensity of the circuit at the predetermined intervals. The simulation photon emission data is used in a fault localization technique.

In another embodiment, a method of localizing a fault in a circuit includes measuring photon emission from the circuit during a test time period to form photon emission data. The measurement is repeated a plurality of test cycles. Further, the photon emission data is digitized. The digitized photon emission data is converted into measured photon emission data based on photon emission intensity of the circuit at predetermined intervals. The measured photon emission data is used in a fault localization technique.

In yet another embodiment, a method of localizing a fault in a circuit includes generating simulation photon emission data for the circuit. Moreover, measured photon emission data for the circuit is generated. The simulation photon emission data is compared with the measured photon emission data to generate a comparison result. Further, the comparison result is classified according to predetermined criteria. The classified comparison result is used in a fault localization technique to determine next action in localizing the fault.

In still another embodiment, a method of localizing a fault in a plurality of circuits includes generating simulation photon emission data for each circuit. The simulation photon emission data of each circuit is merged into a composite simulation photon emission data. Moreover, composite measured photon emission data for the circuits is generated. The composite simulation photon emission data is compared with the composite measured photon emission data to generate a comparison result. Further, the comparison result is classified according to predetermined criteria. The classified comparison result is used in a fault localization technique to determine next action in localizing the fault.

### BRIEF DESCRIPTION OF THE DRAWINGS

The accompanying drawings, which are incorporated in and form a part of this specification, illustrate embodiments of the invention and, together with the description, serve to explain the principles of the present invention.

FIGS. 1-23 illustrate methods of localizing a fault in accordance with an embodiment of the present invention.

### DETAILED DESCRIPTION OF THE INVENTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be recognized by one of ordinary skill in the art that the present invention may be practiced without these specific details.

Software diagnosis makes it possible to investigate many IC defects with fault simulation tools. Faster defect localization can be achieved by combining IC simulations with internal measurements. Internal probing techniques, such as time resolved photon emission (e.g., TRPE), can access “otherwise inaccessible” nodes. Time resolved photon emission records photons emitted during commutations (current changes) rather than changes in logic states (voltage changes). These internal hardware diagnosis tools can fine-tune the defect analysis and validate simulations by contributing “actual” measurements. The combination of software diagnosis and internal probing can reduce simulation time and internal measurements for faster isolation of the root cause of a defect or fault. Comparing measured waveforms with simulations (e.g., Standard Test Interface Language (STIL) or Voltage Change Dump (VCD) formats) localizes functional faults and timing issues. The challenge is to determine quickly if an “actual” measurement is good or not: Can some signal be measured (Is the transistor at least activated)? Are the measured delays matching the simulation? If a problem is detected, the present invention makes it possible to locate rapidly the fault site.

Integrated circuit diagnostics (debug and failure analysis) and characterization employ several techniques—testing, software and internal probing (e.g., time resolved photon emission (TRPE)).

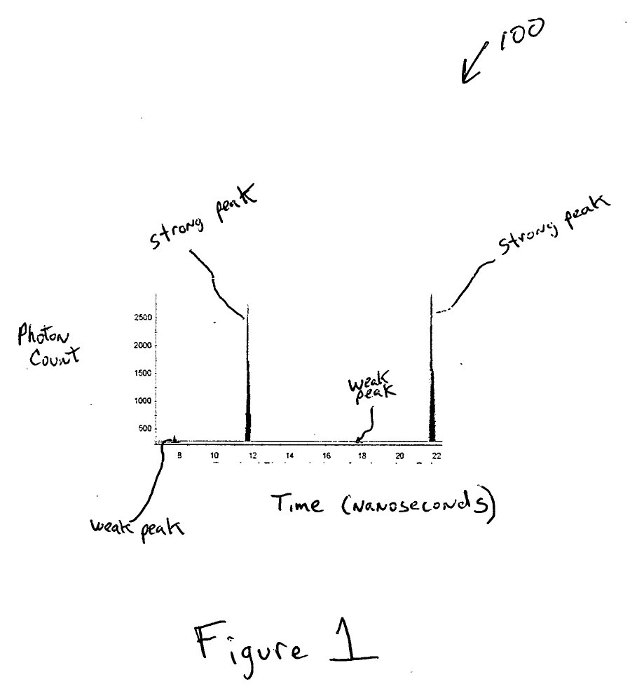

TRPE is a technique to capture photons that are emitted by transistor switching or commutation activity on an integrated circuit (IC) and to record the time of each photon relative to a trigger or timing reference signal. TRPE may incorporate either imaging (PICA) or single element type detectors. PICA is Picoseconds Imaging Circuit Analysis (See J. A. Kash and J. C. Tsang, “Noninvasive Optical Method for Measuring Internal Switching and other Dynamic Parameters of CMOS Circuits”, U.S. Pat. No. 5,940,545, issued Aug., 17, 1999). The PICA detector is an imaging type that records the time (t) and position (x, y) of individual photons. TRPE and PICA data, therefore, contain timing information useful in debug and failure analysis of integrated circuits and photon count, as illustrated by the graph 100 of FIG. 1. The graph 100 shows two strong photon emission peaks and two weak photon emission peaks. A single element detector provides only timing data (t) from a local x, y region. A Photon Emission Microscope (PEM) camera records the position (x, y) of the sum of the optical emission from all switching events during the acquisition period.

Typically, test and validation of logic in a design is done using signals defined by voltage levels. A sequence of 0's and 1's describe the input or output waveform for any points in a circuit. Internal probing of a device with either an e-beam prober or a laser voltage prober (LVP) makes it possible to measure the logic waveforms inside the device itself. Comparison of these measurements with simulation, for example, reveals disparities when a problem exists. However useful these tools are in general there are specific cases for which they do not work. E-beam probing requires physical access to the node being investigated (e.g., the metal interconnect). This is very challenging in present day integrated circuits due to multiple levels of metallization and/or flip-chip packaging. Further the need to cool a flip chip package makes this completely unworkable through the silicon “back” side. The LVP is proving itself more useful than was believed several years ago, especially for timing measurements, but for silicon-on insulator (SOI) devices LVP has not been workable.

TRPE and PICA on the other hand record photons emitted due to current variation rather than changes in voltage/logic states. The timing information obtained with TRPE and PICA while very precise is not compatible with existing testing tools. Histogram peaks (the optical waveforms) for some commutations are higher, i.e., contains more photons, than for other commutations and therefore are more readily classified. For example, a higher number of photons are collected from the NMOS transistor of an inverter whose output is switching from 1 to 0 than when it is switching from 0 to 1. For the PMOS transistor in the inverter, more photons are generated when the transistor switches from 0 to 1 than from 1 to 0.

Photoemission from silicon devices such as an NMOS transistor that is pertinent to photon emission microscopy (PEM), TRPE and PICA is due to the generation of hot carriers, which have the highest probability of occurring when the transistor is switched ON via the V_{GS} voltage and sufficient V_{DS} is present while current is flowing through the channel to place the transistor in a saturation state, i.e., during commutation.

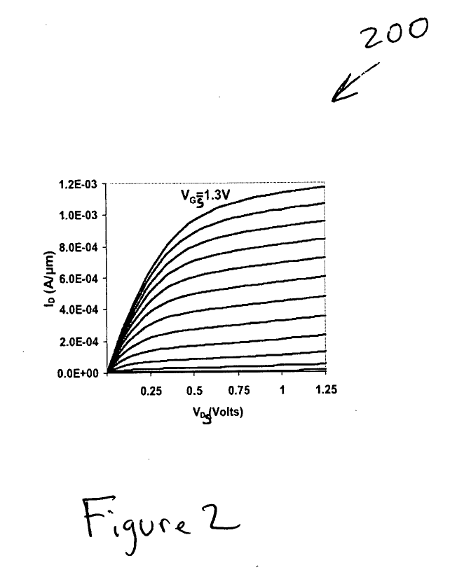

In addition to the substrate, an NMOS transistor has 3 nodes: gate G, drain D, and source S. From the electrical point of view, two quantities are considered—the gate to source voltage V_{GS} and the drain to source voltage V_{DS}. From a logic point of view, V_{GS} and V_{DS} are considered either logic 1 (>V_{T}) or logic 0 (<V_{T}). The threshold value V_{T} comes from the circuit I-V curves illustrated in graph 200 of FIG. 2.

Again, for the PMOS transistor photoemission from silicon devices that is pertinent to PEM, TRPE and PICA is due to the generation of hot carriers, as described for the NMOS transistor, i.e., during commutation. In addition to the substrate, a PMOS transistor also has 3 nodes: gate G, drain D, and source S. From the electrical point of view, two quantities are considered—the gate to source voltage V_{GS} and the drain to source voltage V_{DS}. In a typical CMOS device, a PMOS and NMOS pair forms the output stage in which drains of each device are electrically tied together. During logic switching operation, the possibility exists that both devices might be on for a brief moment resulting in photoemission from the NMOS via PMOS commutation activity. This is another mechanism by which photoemission from PMOS commutations can be observed.

As the voltage of ICs (integrated circuits) has decreased at each new process node, the signal that can be collected has also decreased. This means that the time to make a measurement has increased. Yet the number of transistors on a chip keeps increasing so the measurement time is growing exponentially. The PICA camera has poor photon detection (or quantum efficiency) when testing devices operating at low voltages (Vdd near 1V). Other detectors used for TRPE are fairly exotic—InGaAs and super conducting Nb or NbN thin film based detectors. The cameras used for PEM are also getting more exotic—from silicon CCD's with thinned substrates to InGaAs, InSb, and MCT focal planar arrays (FPAs) and others. Even with the improved quantum efficiencies of these detectors, defect/fault localization is still challenging (design or process related) as the number of transistors increases on the IC chip, increased levels of metallization, smaller spacing, new materials, and increased transistor and interconnect density. The present invention decreases the time to make a decision in any localization technique utilized to localize the defect/fault.

Currently, there are several standards for voltage waveform simulations, such as STIL, VCD, Wave generation Language (WGL), etc. Previously, the transfer of data from simulation into the Automated Test Equipment (ATE) environment has been through the proprietary language of the specific ATE system. Value Change Dump (VCD) formats have been the typical way of capturing simulation output. The language is flexible enough to represent patterns from simple to the most complex devices, and has built in optimizing features to minimize the volume of data. VCD records every transition on each pin of the simulated device as a sequence of timed events and logic levels (1's or 0's). This is fine for displaying a picture of the waveform, however it has limitations when used for creating test programs. VCD does not allow for any representation of the relation between events that is needed for any kind of analysis or characterization of the pattern from a real device. The VCD format requires an involved process to make the waveform/pattern realizable on most ATE systems which is usually done by means of expensive and time consuming conversion software.

In response to this issue and specifically to address growing concerns with large volumes of test data, an industry consortium of IC producers and ATE manufacturers came together to develop a Standard Test Interface Language (STIL) and is now part of standards committee (IEEE Std 1450.0-1999). STIL is designed to transfer high-density digital test patterns between simulation data created in Computer-Aided Engineering (CAE) environments, automatic test pattern generation (ATPG) programs, built-in-self-test (BIST) data, and ATE equipment.

A tester (e.g., ATE equipment) is generally needed to activate the device while the probing tool acquires data. Converting ATE test vector data into a standard logic level format such as STIL provides a more efficient and easier means to review the data and consequentially debug and characterize the device. The data conversion tools are generally part of the ATE tools suite.

While current simulation software tools have improved the methods of processing and displaying large volumes of data, the data is stored in logic level or voltage level formats which is not readily compatible with the data formats recorded by PEM, TRPE and PICA optical probing tools.

A discussion of prior art methods for fault localization may be found in U.S. Pat. No. 6,526,546 entitled “Method for locating faulty elements in an integrated circuit,” issued Feb. 25, 2003, which is hereby incorporated herein by reference.

Simulated and Measured Time Resolved Photon Emission Data

Methods for using measured time resolved photon emission data and simulated time resolved photon emission data for fault localization are provided and described. In one embodiment, a method of localizing a fault in a circuit includes generating simulation data based on logical states of the circuit at predetermined intervals. Moreover, the simulation data is converted into simulation photon emission data based on photon emission intensity of the circuit at the predetermined intervals. The simulation photon emission data is used in a fault localization technique.

In another embodiment, a method of localizing a fault in a circuit includes measuring photon emission from the circuit during a test time period to form photon emission data. The measurement is repeated a plurality of test cycles. Further, the photon emission data is digitized. The digitized photon emission data is converted into measured photon emission data based on photon emission intensity of the circuit at predetermined intervals. The measured photon emission data is used in a fault localization technique.

In yet another embodiment, a method of localizing a fault in a circuit includes generating simulation photon emission data for the circuit. Moreover, measured photon emission data for the circuit is generated. The simulation photon emission data is compared with the measured photon emission data to generate a comparison result. Further, the comparison result is classified according to predetermined criteria. The classified comparison result is used in a fault localization technique to determine next action in localizing the fault.

In still another embodiment, a method of localizing a fault in a plurality of circuits includes generating simulation photon emission data for each circuit. The simulation photon emission data of each circuit is merged into a composite simulation photon emission data. Moreover, composite measured photon emission data for the circuits is generated. The composite simulation photon emission data is compared with the composite measured photon emission data to generate a comparison result. Further, the comparison result is classified according to predetermined criteria. The classified comparison result is used in a fault localization technique to determine next action in localizing the fault.

In one aspect of the present invention, a method to compare the expected performance of the device—the simulations—to actual internal measurements from the device, for example the photon emissions/optical waveforms is provided. For example, the voltage/logic level simulation data generated by CAD/EDA tools can be exported in STIL, VCD or other useful data format which then can be converted into a photoemission compatible format such as a histogram indicating logic level transitions. This enables the fast localization of a discrepancy and therefore the identification of a design or process issue. Once a design has been validated, any observed discrepancy would be a failure due to fabrication process issues, design marginality, or to misuse of the device.

Another aspect of the present invention is to provide the feedback from the “actual”measurements to the CAD/EDA models. For example, this might be performed by processing the actual photoemission data that can be in a histogram vs. time format and converted to a logic level format such as STIL, VCD or other useful data format by discerning which histogram transitions represent a 0 to 1 transition vs. a 1 to 0 transition. This is extremely valuable as it provides feedback to fine tune the models used by design.

In an embodiment of the present invention, simulated “optical waveforms” (or simulated time resolved photon emission data) are generated from simulated logic waveforms (typically in STIL or VCD format). Data processing is applied to correlate the simulated optical waveforms to actual optical waveforms (or measured time resolved photon emission data) with a minimum amount of real data as needed to provide sufficient confidence to determine the circuit to be functional or defective. The simulated logic waveforms providing the change of logic state information are used for generating the simulated optical waveforms. Also, in generating the simulated optical waveforms a variety of knowledge is used, where the knowledge can be the photon emission yield from a device which occurs due to a logic state change, which is a function of the transistor type (p or n channel), size, operating voltage, and fabrication process used.

Moreover, the invention enables the reconstruction of logic waveforms from PICA, TRPE and other optical waveform measurements. The invention may also be used in conjunction with the application of a differential laser voltage probing tool. An example of such a tool is described in U.S. Pat. No. 6,252,222, entitled “Differential Pulsed Laser Probing of Integrated Circuits,” issued Jun. 26, 2001, which is hereby incorporated herein by reference. Further, the invention may be used with static photon emission. For example, simulated optical emission of a device can be performed. All emission events occurring during a specified period of time are added, yielding an expected cumulative emission height for that device which can be compared against actual static emission data. Although static photon emission would not show the waveforms it would tell, through peak height analysis, if the transistor is switching as would be appropriate for a properly functioning device.

This invention further includes a technique for faster fault localization that can be achieved by combining IC emission simulations with the internal optical probing measurements. The combination of simulation and internal probing of otherwise “inaccessible nodes” may be necessary to locate a fault in the heart of a device. Time resolved photoemission (TRPE) makes it possible to acquire precise timing waveforms corresponding to transistor commutations. A new data format is created, which contains simulated emission peaks (current levels). An example of this new data format is the TRPE_{VCD} (or TRP_{VCD}) format or the TRPE_{STIL} (or TRP_{STIL}) format. In one embodiment, the simulated emission in the new data format is derived from the logic “0” and “1” simulation (voltage/logic levels) data, the transition points of the logic level data, and a scaling factor based on the specifics of the transistor as mentioned earlier. Actual TRPE measurements are acquired and converted into a TRP_{STIL} format or TRP_{VCD} and compared to the simulated emission in order to generate a quick diagnosis: Is the gate working? Is there a timing issue? With a few measurements, the fault site can be located.

This invention further includes a method to rapidly decide whether a circuit node of a device is functioning correctly or not by defining a statistical confidence level as criteria to determine how many photons need to be collected to be statistically significant without spending unnecessarily amount of acquisition time which otherwise does not add any relevance to the measurement.

Methods and apparatus for obtaining optical data for use in conjunction with the present invention may be found in U.S. patent application Ser. No. 10/234,231, entitled “Apparatus and Method for Detecting Photon Emissions from Transistors,” filed Sep. 3, 2002, by Desplats et al., and in U.S. patent application entitled “Time-Resolved Optical Probing (PICA) with CAD Auto-Channeling for Faster IC Debugging,” filed Dec. 5, 2002 by Desplats et. al., both of which are hereby incorporated herein by reference.

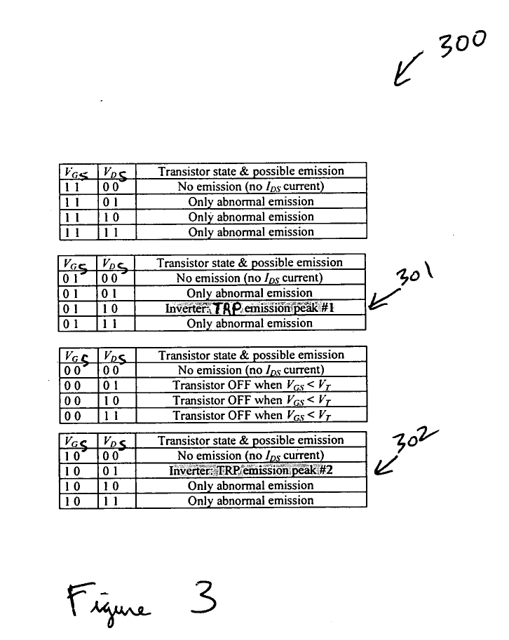

To convert “voltage/logic” information into a “current/emission” waveform, the electrical behavior of the circuit (e.g., transistor, logic gates, logic blocks, etc.) is needed. For the case of an NMOS transistor, all logic states and commutations are reviewed to understand the conditions for photoemission. From the static behavior (or truth table), a dynamic mode is built in order to show commutations and thus current/emission variations. Considering that photoemission is most probable when the transistor is switched ON via the V_{GS} voltage and sufficient V_{DS} is present while current is flowing through the channel to place the transistor in a saturation state, all transitions of V_{GS} and V_{DS} and expected emission are represented in a truth table 300 as illustrated in FIG. 3. As depicted in truth table 300, these conditions are possible only in two cases 301 and 302, when the input V_{GS} and the output V_{DS} switch states from 0 to 1 and vice-versa.

Outside of switching in the CMOS architecture, saturation conditions occur only for a fault, as suggested in truth table 300 by “abnormal emission”. Techniques such as I_{DDQ} testing, Photon Emission Microscopy (PEM) and TLS (thermal laser stimulation) such as OBIRCH/TIVA/Seebeck Effect Imaging are often sufficient to locate the origin of these non-switching faults. In the TRPE analysis flow, the focus is on two possible emission peaks.

For initial illustration, the inverter is a good case. Further examples involve the analysis of the expected coverage of the truth table for CMOS structures such as NAND gates and XOR gates.

The invention may also be used with optically triggered devices such as those disclosed in U.S. Pat. No. 6,501,288, entitled “On-Chip Optically Triggered Latch for IC Time Measurements,” issued Dec. 31, 2002, which is hereby incorporated herein by reference.

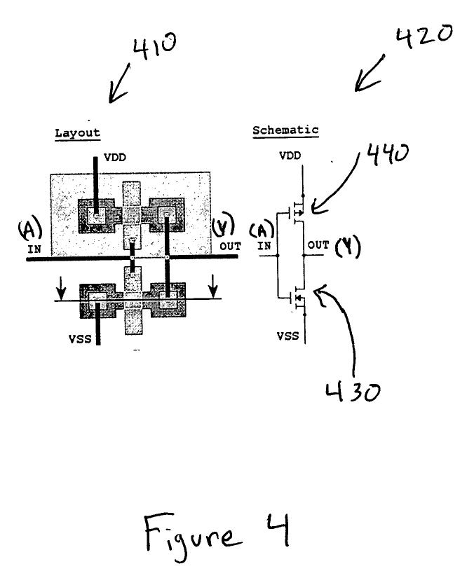

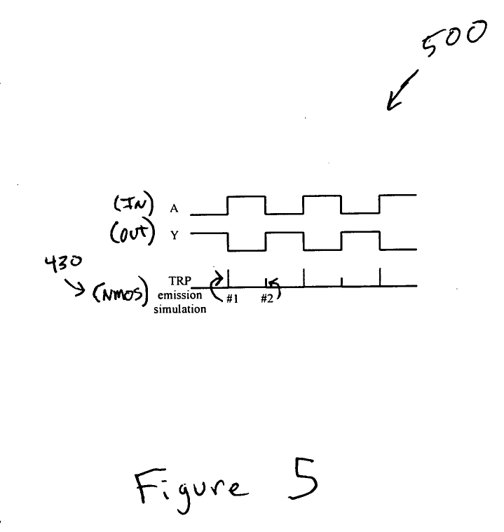

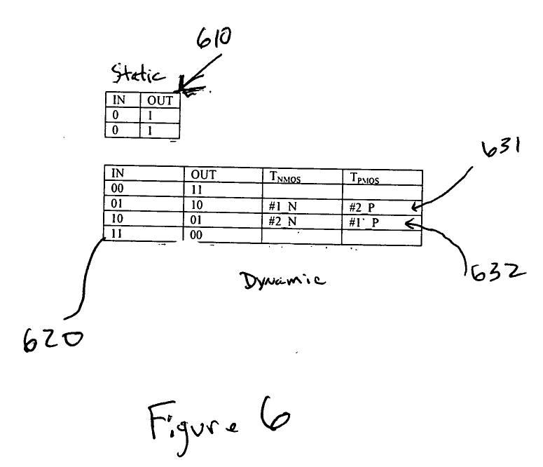

Again, as for the NMOS transistor, possible normal TRP emissions (or TRPE) occur only when both the input V_{GS} and the output V_{DS} of the transistor commutate in an opposite manner. For the inverter (FIG. 4 shows a layout 410 and a schematic 420 of the inverter), all possibilities are determined from simulation 500 as depicted in FIG. 5 and then listed in static truth table 610 and dynamic truth table 620 of FIG. 6. The simulation 500 of FIG. 5 shows voltage/logic state transitions in the input A and the output Y of the inverter of FIG. 4. Moreover, the simulation 500 depicts TRP emissions (or TRPE) associated with the NMOS 430 of the inverter of FIG. 4. TRP emission (or TRPE) labeled #1 represents a strong photon emission peak while the TRP emission (or TRPE) labeled #2 represents a weak photon emission peak.

As depicted in FIG. 6, TRP emission may happen only in two cases 631 and 632—when the inverter (FIG. 4) is switching from 0 to 1 and vice-versa. The column labeled T_{NMOS} displays TRP emissions for the NMOS Transistor 430 of the inverter (FIG. 4) while the column labeled T_{PMOS} displays TRP emissions for the PMOS Transistor 440 of the inverter (FIG. 4). Moreover, the columns T_{NMOS} and T_{PMOS} indicate the type of TRP emission (e.g., #1 represents a strong photon emission peak, #2 represents a weak photon emission peak). In case 631, the NMOS transistor 430 of the inverter (FIG. 4) generates a strong photon emission (shown as peak #1 in FIG. 5) while the PMOS transistor 440 generates a weak photon emission. In case 632, the NMOS transistor 430 of the inverter (FIG. 4) generates a weak photon emission (shown as peak #2 in FIG. 5) while the PMOS transistor 440 generates a strong photon emission. For more complex gates such as NOR and NAND, this rule can be applied to create a dynamic truth table for TRP emissions.

To validate the functionality of a logic device, it is not necessary to cover all possible states. For the case of a NAND gate, the output may switch to 0 only if all inputs are at 1. As long as at least one input stays 0 it is not possible to validate the functionality of the NAND gate. (This is important as functionality can only be verified when all inputs are toggled high.) The truth table corresponds to all possible static state. Since photoemission in CMOS devices occurs only briefly during commutation, a dynamic truth table is necessary to cover the possible TRP emissions.

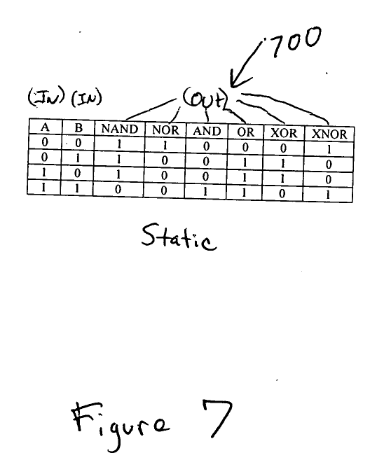

In FIG. 7, the static truth table 700 for a variety of basic CMOS gates is shown. The static truth table 700 is derived to cover the different possibilities of photoemission (peak #1 or peak #2) for both NMOS and PMOS transistors.

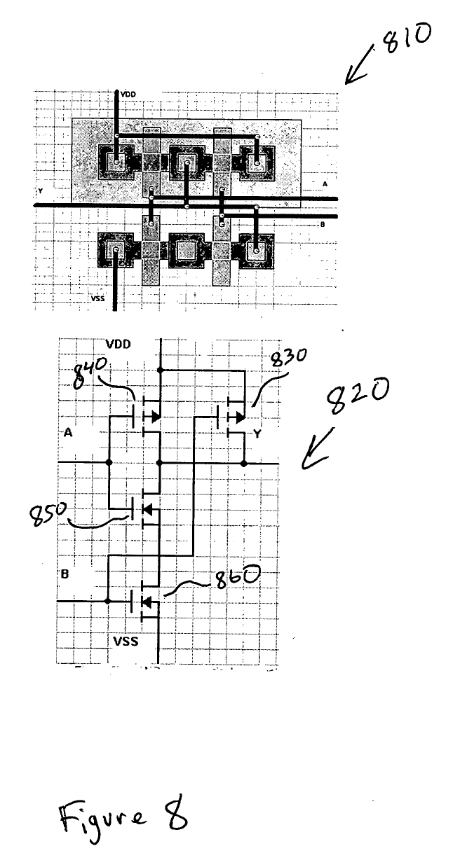

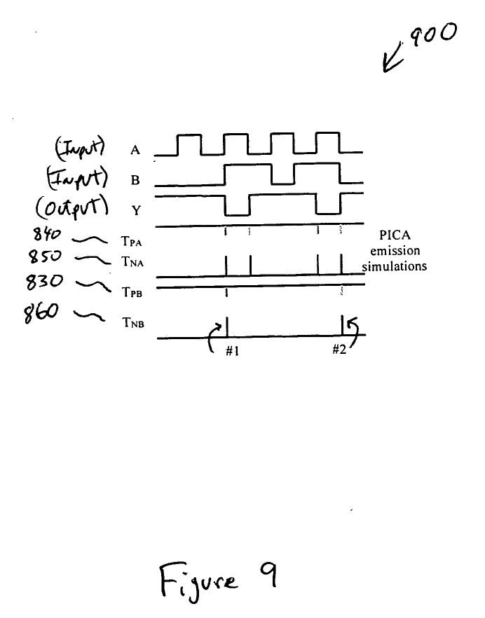

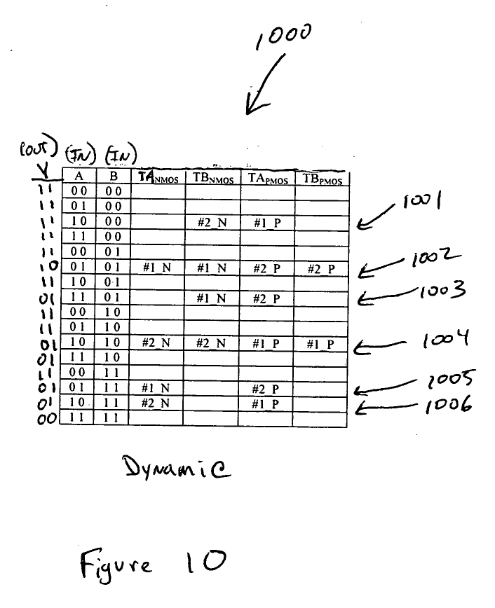

For the NAND gate (FIG. 8 shows a layout 810 and a schematic 820 of the NAND gate), all possibilities of photoemission are determined from simulation 900 as depicted in FIG. 9 and then listed in dynamic truth table 1000 of FIG. 10. As shown in FIG. 8, the schematic 820 of the NAND gate includes NMOS transistors 850 and 860 and includes PMOS transistors 830 and 840. The simulation 900 of FIG. 9 shows voltage/logic state transitions in the inputs A and B and voltage/logic state transitions in the output Y of the NAND gate of FIG. 8. Moreover, the simulation 900 depicts TRP emissions (or TRPE) associated with the NMOS and PMOS transistors 830-860 of FIG. 8, where T_{PA} represents photon emissions by PMOS 840, T_{NA} represents photon emissions by NMOS 850, T_{PB} represents photon emissions by PMOS 830, and T_{NB} represents photon emissions by NMOS 860. TRP emission (or TRPE) labeled #1 in T_{NB} represents a strong photon emission peak while the TRP emission (or TRPE) labeled #2 in T_{NB} represents a weak photon emission peak.

Symmetry is used to construct the dynamic truth table 1000 (FIG. 10) for a NAND gate (FIG. 8). The output Y is 1 if at least one input is 0 (see FIG. 9). The dynamic truth table 1000 is limited to 6 (e.g., cases 1001-1006 of FIG. 10) out of 16 possibilities: photon emission does not occur during the 4 static configurations, leaving 12 possibilities. Due to symmetry in the NAND gate (FIG. 8), photon emission occurs in half the remaining commutations of the inputs (See FIG. 10). In the dynamic truth table 1000 of FIG. 10, the columns labeled TA_{NMOS}, TB_{NMOS}, TA_{PMOS}, and TB_{PMOS} display TRP emissions for the transistors 850, 860, 840, and 830, respectively. Moreover, the columns TA_{NMOS}, TB_{NMOS}, TA_{PMOS}, and TB_{PMOS} indicate the type of TRP emission (e.g., #1 represents a strong photon emission peak, #2 represents a weak photon emission peak).

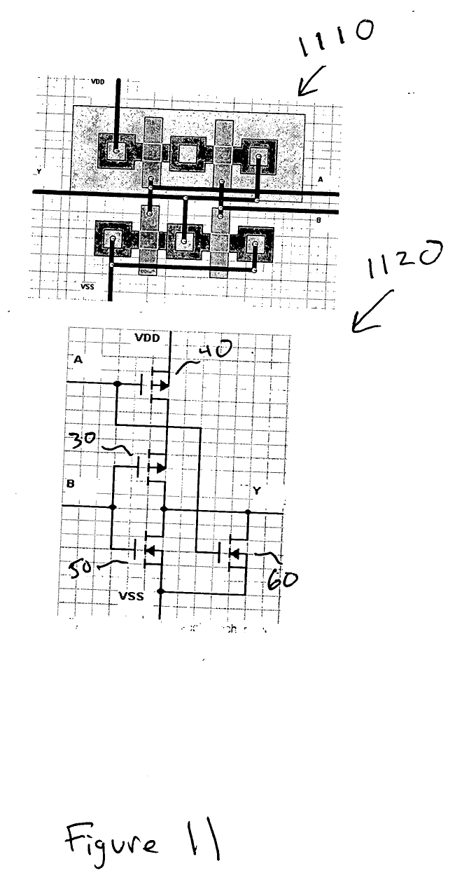

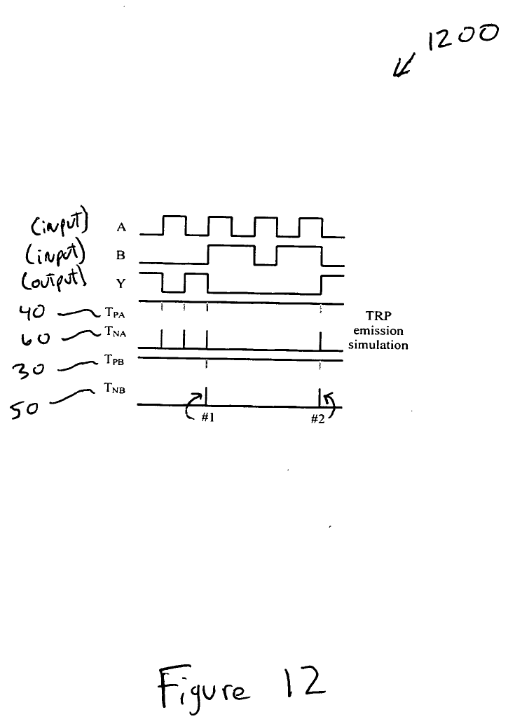

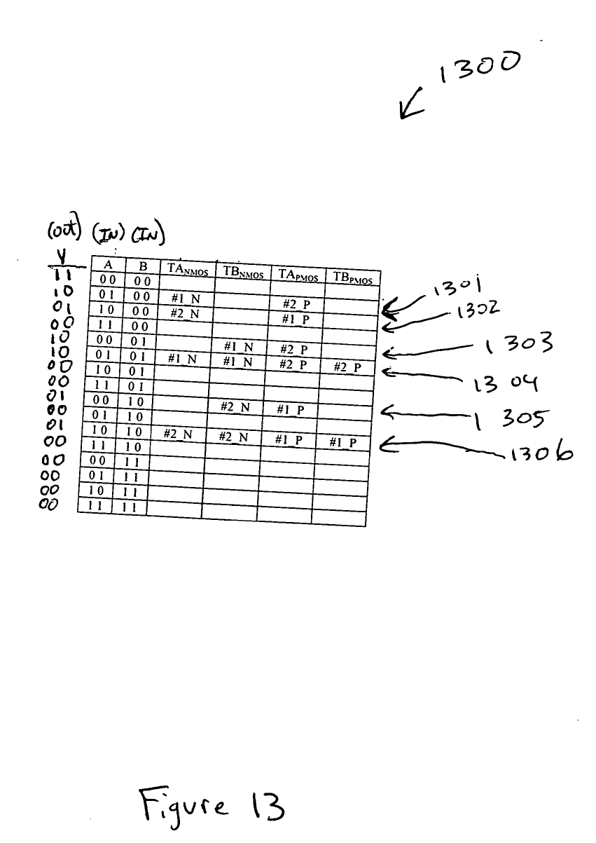

For the NOR gate (FIG. 11 shows a layout 1110 and a schematic 1120 of the NOR gate), all possibilities for photoemission are determined from simulation 1200 as depicted in FIG. 12 and then listed in dynamic truth table 1300 of FIG. 13. As shown in FIG. 11, the schematic 1120 of the NOR gate includes NMOS transistors 50 and 60 and includes PMOS transistors 30 and 40. The simulation 1200 of FIG. 12 shows voltage/logic state transitions in the inputs A and B and voltage/logic state transitions in the output Y of the NOR gate of FIG. 11. Moreover, the simulation 1200 depicts TRP emissions (or TRPE) associated with the NMOS and PMOS transistors 30-60 of FIG. 11, where T_{PA} represents photon emissions by PMOS 40, T_{NA} represents photon emissions by NMOS 60, T_{PB} represents photon emissions by PMOS 30, and T_{NB} represents photon emissions by NMOS 50. TRP emission (or TRPE) labeled #1 in T_{NB} represents a strong photon emission peak while the TRP emission (or TRPE) labeled #2 in T_{NB} represents a weak photon emission peak.

The static table 700 of FIG. 7 shows the NOR gate output is 0 if at least one input is 1. Therefore the interest is when all inputs commute to 1 and when at least one input switches to 0. This limits the dynamic truth table 1300 (FIG. 13) to 6 cases 1301-1306 where photoemission occurs. In the dynamic truth table 1300 of FIG. 13, the columns labeled TA_{NMOS}, TB_{NMOS}, TA_{PMOS}, and TB_{PMOS} display TRP emissions for the transistors 60, 50, 40, and 30, respectively. Moreover, the columns TA_{NMOS}, TB_{NMOS}, TA_{PMOS}, and TB_{PMOS} indicate the type of TRP emission (e.g., #1 represents a strong photon emission peak, #2 represents a weak photon emission peak). Plotting voltage variation as well as possible TRPE current peaks, the symmetry between n-transistors and p-transistors, is clear (see FIG. 12). Only looking at the n-transistors, for each voltage change on the output, a possible emission peak is seen. It means that the possibility to transform the TRP emission peak into a state level exists.

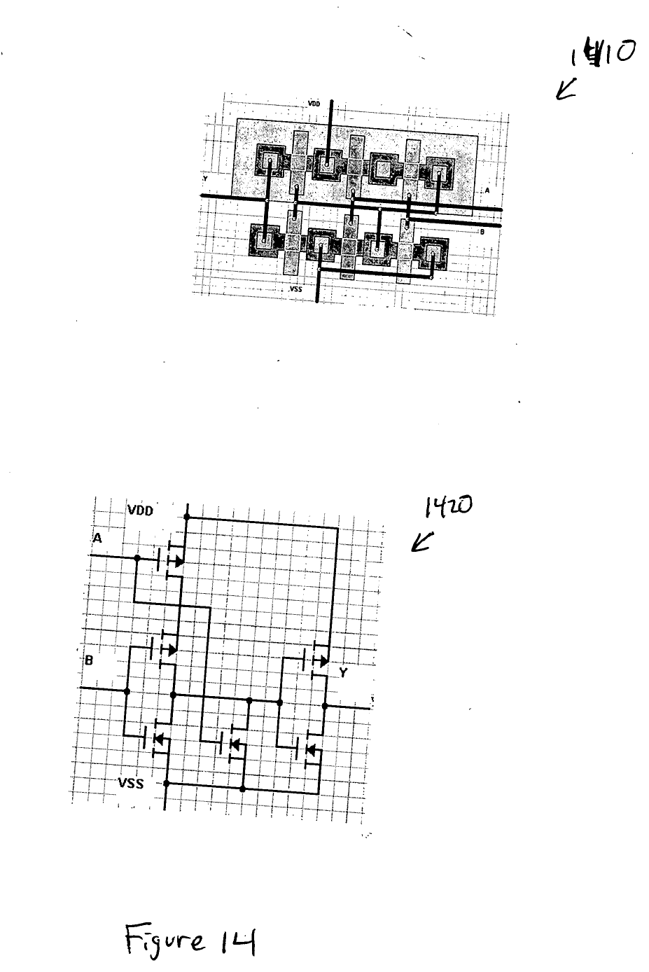

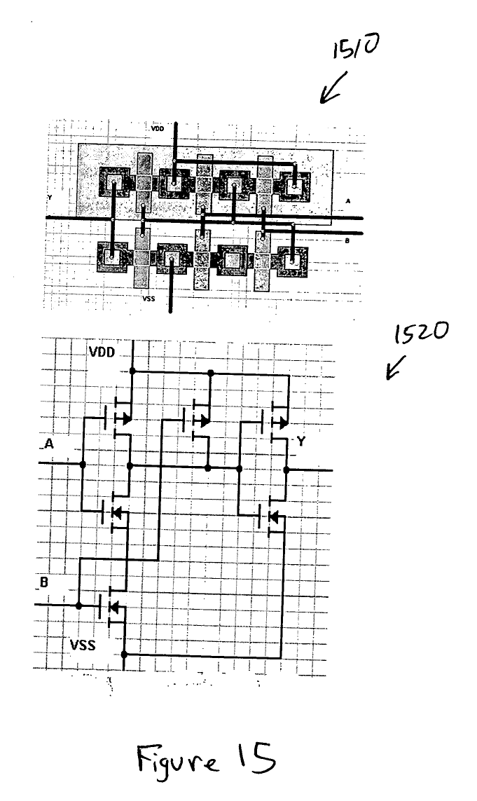

The OR gate (FIG. 14 shows a layout 1410 and a schematic 1420 of the OR gate) and AND gate (FIG. 15 shows a layout 1510 and a schematic 1520 of the AND gate) are identical to the NOR and NAND gates (FIGS. 11 and 8, respectively) above except the output goes through an INVERTER at the final stage.

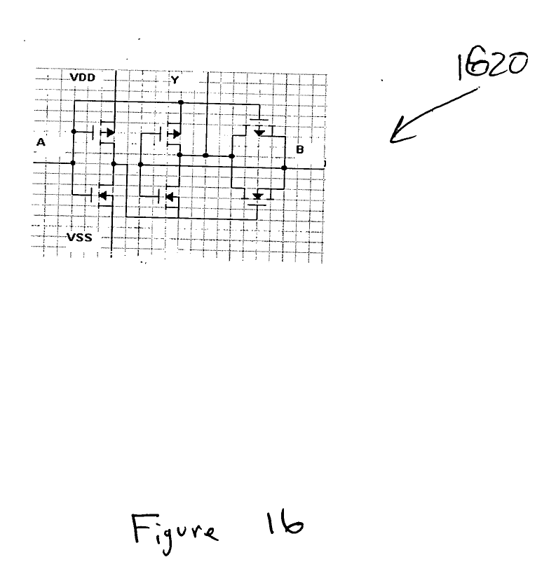

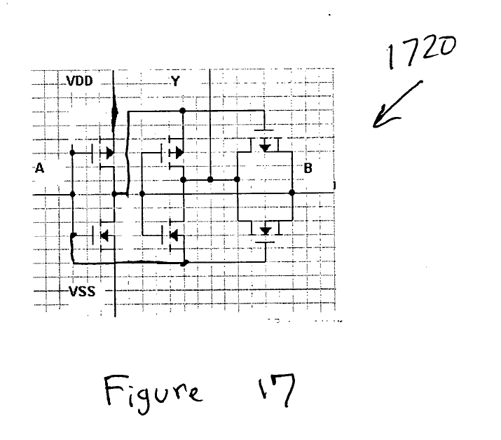

Increasing the gate complexity of CMOS structures to a 6 transistor XOR (FIG. 16 shows a schematic 1620 of the XOR gate), its output is 0 if all inputs are identical. As for a NAND gate or NOR gate, TRP emission may be monitored on the n-transistors. By symmetry, the XNOR gate (FIG. 17 shows a schematic 1720 of the NXOR gate) information is contained in the p-transistors.

Due to symmetry of logic gates in CMOS technology, probing n-transistors only can monitor the output waveform. Probing p-transistors yields the same results even though the photon emissions seem to be weaker and of longer wavelength. The coverage of the truth table is obtained only if all n-transistors connected to the output are probed. However, as a rule of thumb, a 2 input gate is probed at two locations and a 4 input gate at 4 locations. After this detailed review of the dynamic truth table, the role of “dynamic” emission peaks (current) versus “static” logic states (voltage) appears clear. For the NOR gate (FIG. 11), as for example, there are 6 possible emission cases out of the 16 transitions while there is only 1 logic change out of 4.

As photoemission occurs only when a transistor switches (note: channel leakage does occur when the transistor is in the off state but is small in present technologies), only rise and fall of a logic state are discernable. In other words, the optical waveforms (e.g., TRPE) identify when a logic transition occurred. With the goal of reconstructing logic waveforms based on these emission peaks, it is necessary to see if it possible to differentiate emission from rising edges and emission from falling edges. Otherwise, reconstructing a logic state is difficult.

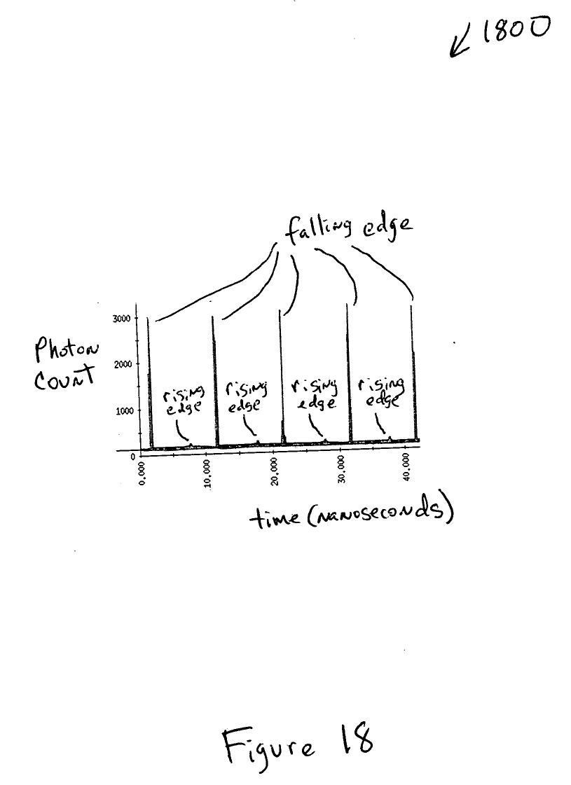

In previous paragraphs, emission peaks have been classified as #1 and #2 for both N and P transistors. While these were represented differently for clarity purpose, the emission physics helps clarify what rising and falling transitions may be identified. Emission of photons associated with TRPE is related to hot electron generation occurring in the strong electron field during saturation. While photon emission is possible with hot holes, factors such as their lower mobility makes the probability much lower than for hot electrons. Comparison of emission peaks measured on NMOS and PMOS transistors of inverter chains shows a much higher photon count from N-transistors. Under the following conditions: small size (e.g., 0.1 μm), low power (e.g., 1.2 V), photon emission detection technologies showed that photon counts from P-transistors are too close to the noise level to be consistent and therefore unreliable as a diagnostic tool. However, photon emission from the N-transistors also varies due to transistor load and, presumably, design-specific issues. For inverters, photon count rate for NMOS over PMOS is approximately 10 times higher when the output is switching from 1 to 0 (falling edge) than from 0 to 1 (rising edge). The graph 1800 of FIG. 18 shows emission peaks for falling edges and rising edges. Therefore, logic state identification is possible.

Thus far, the conclusion is that the TRPE data may enable reconstruction of logic states. The problem arises is that if very few photons are detected for 0 to 1 (rising edge) commutations, it may always be possible to determine if a commutation occurred or that the few photons are just coming from the background noise. To capture the fainter P-transistor emissions with sufficient confidence level, acquisition time goes from minutes to several 10's of minutes. Acquisition times become even more discouraging as counts drop exponentially with the lower power supply voltage in new technologies.

Viewed from a practical approach, an alternative is needed—Can fault localization be done with short measurement times? This would not capture all rising commutations and thus leave uncertainty in 0 to 1 transitions.

To overcome this indetermination, a new data format for the Time Resolved Photon Emission is introduced to describe emissions (linked to a current) instead of a logic state (linked to a voltage level). This new data format is beneficial to any fault localization technique utilized. This new data format can be directly derived from logical (voltage) simulations.

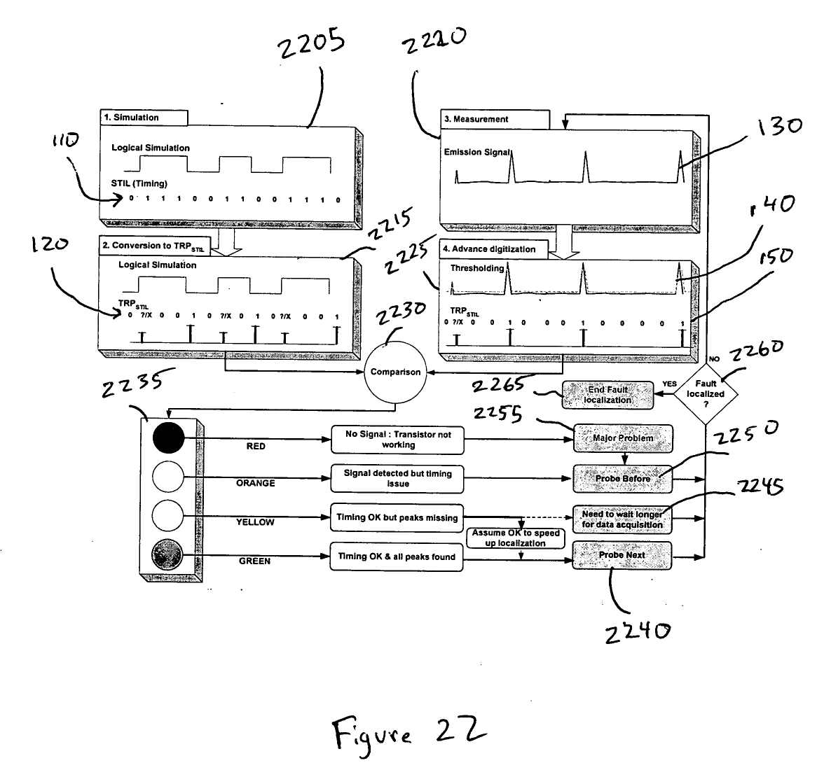

Simulation logic waveforms are available in different industry standard formats such as Verilog-VCD, WGL, STIL, etc. The variety of formats has created duplicated effort for each vendor to interpret the format. In response to this issue and specifically to address growing concerns with large volumes of logic (voltage) test data, an industry consortium of IC manufacturers and ATE manufacturers came together to develop the Standard Test Interface language (STIL). For purpose of describing the present invention, reference is made to standard test vector data format, with the goal being to interface with the STIL vector data format specification. [Note: Verilog-VCD is an efficient way to dump value changes of variables in the design hierarchy and has been proved for performance and storage optimization.] In standard test data format, the series of logic states 0's and 1's is stored to represent the voltage logic levels as Low (L) and High (H). From the photon emission perspective, only changes between logic states are meaningful. Therefore, in order to compare Time Resolved Photon Emission (or TRP emission) waveforms with simulations (STIL or VCD or other voltage-based waveforms), new data formats are introduced: TRP_{STIL} or TRP_{VCD}. These new data formats represent commutation changes instead of logic states as seen in standard test vector data. An example of a test vector data for a simulation waveform converted to the simulation TRP_{STIL} format is shown in FIG. 22.

As depicted in FIG. 22, the STIL-formatted simulation data 110 is converted to simulation TRP_{STIL} data 120 (or simulation photon emission data). Since photon emission occurs during commutations, 1's are attributed to photon emission and 0's indicate no emission in simulation TRP_{STIL} data 120. With this terminology, TRP_{STIL} 120 can be derived from logic/voltage STIL waveforms 110 and, further, the vice-versa is possible. To refine the Time Resolved Photon Emission, the lower probability of detecting photons for 0 to 1 commutations is addressed by adding a separate state value for the rising edge transitions on the output: “?/X” (for weaker photon emission peaks) while the falling edge has a state value of 1 (for stronger photon emission peaks). From experimentation, the ratio between the peak for falling edge and the peak for rising edge is often greater than 10.

Thus, one embodiment of the TRP_{STIL} format has 3 state values are possible: 0 (no TRPE emission); 1 (TRPE emission, falling edge); and “?/X” (Possible photon emission indicative of small rising edge peaks). In a second embodiment of the TRP_{STIL} format, the sub-threshold leakage current, which occurs when the transistor is ‘off’ is also taken into account. This added capability makes it possible to go beyond timing related faults and to tackle leakage problems, which grow in importance with each new process technology.

In one embodiment, time resolved photon emission probing, preferably from the backside, is used for measurements. That is, the photon emissions are detected with respect to a reference time. This technique makes it possible to measure precise signal waveforms through the silicon backside in order to obtain timing/delay information.

To locate defects/faults using internal probing, each measured waveform must be compared with a simulation logic waveform. To meet this goal, simulation logic waveforms (STIL or VCD format, for example) are first converted to the TRP_{STIL} format to serve as references for internal measurements and comparison.

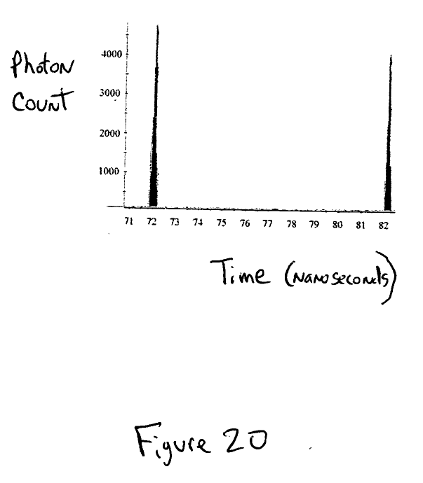

Continuing, another step is to convert this photon emission measurement (analog waveform) into a waveform in the TRP_{STIL} format. In a TRPE measurement instrument such as the NPTest IDS SSPD (Superconducting Single Photon Detector) or the IDS PICA system, the photon emission measurement (analog waveform) is digitized. In one embodiment, this digitization is done using a variable threshold with a Gaussian fit (FIG. 20 shows digitization of analog photon emission measurement for a NOR gate), only the peaks are taken into account. However, the sub-threshold current variation can be taken into account in order to increase the sensitivity to track subtle faults in the latest semiconductor technologies (e.g., size <100 nm).

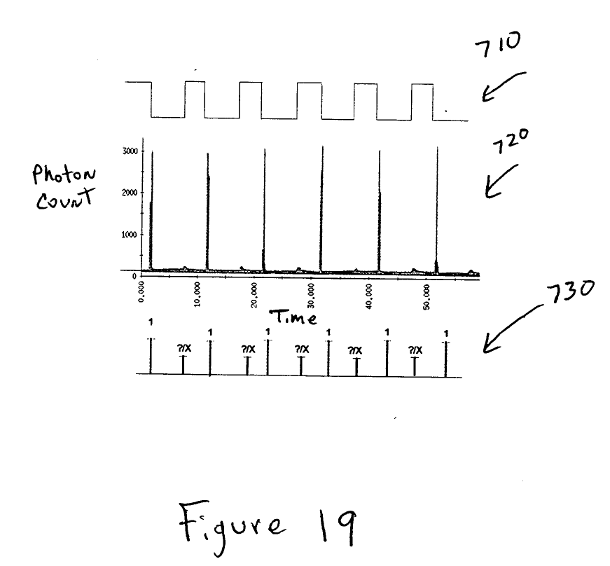

In FIG. 19, the photon emission measurement for an NMOS device with the IDS SSPD system is shown. More specifically, logic (voltage) data 710, measured analog photon emission data 720, and digitized photon emission peaks 730 are depicted in FIG. 19.

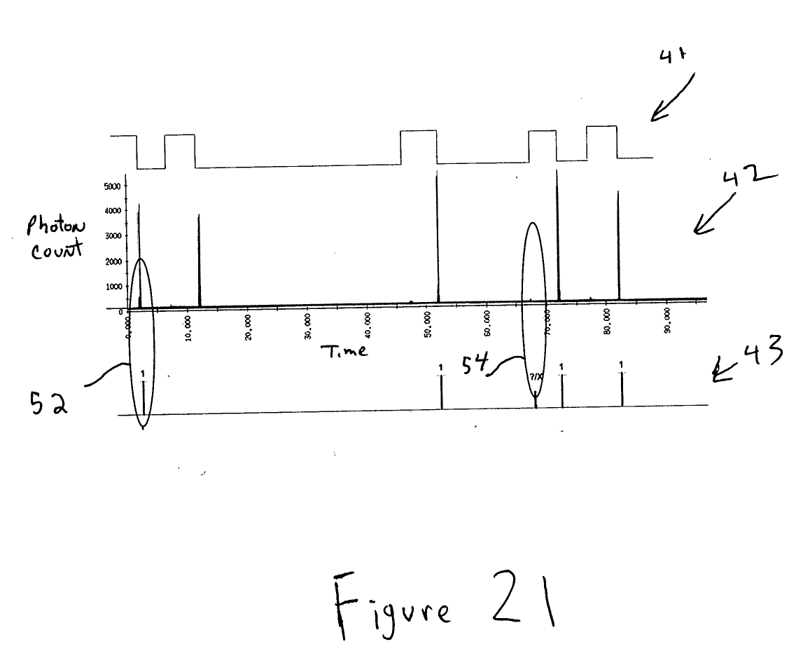

Moreover, in FIG. 21, the photon emission results for one N-transistor of a NOR gate is presented. More specifically, logic (voltage) data 41, measured analog photon emission data 42, and expected digitized photon emission peaks 43 are depicted in FIG. 21. In this case, not all weak photon emission peaks are detected. The reference 52 shows that a strong photon emission peak is detected while the reference 54 shows that a weak photon emission peak was not detected.

From the above discussion, it is evident that simulation TRP_{STIL} waveform can now be readily compared to the actual photon emission measurement from the internal node, generating a comparison result.

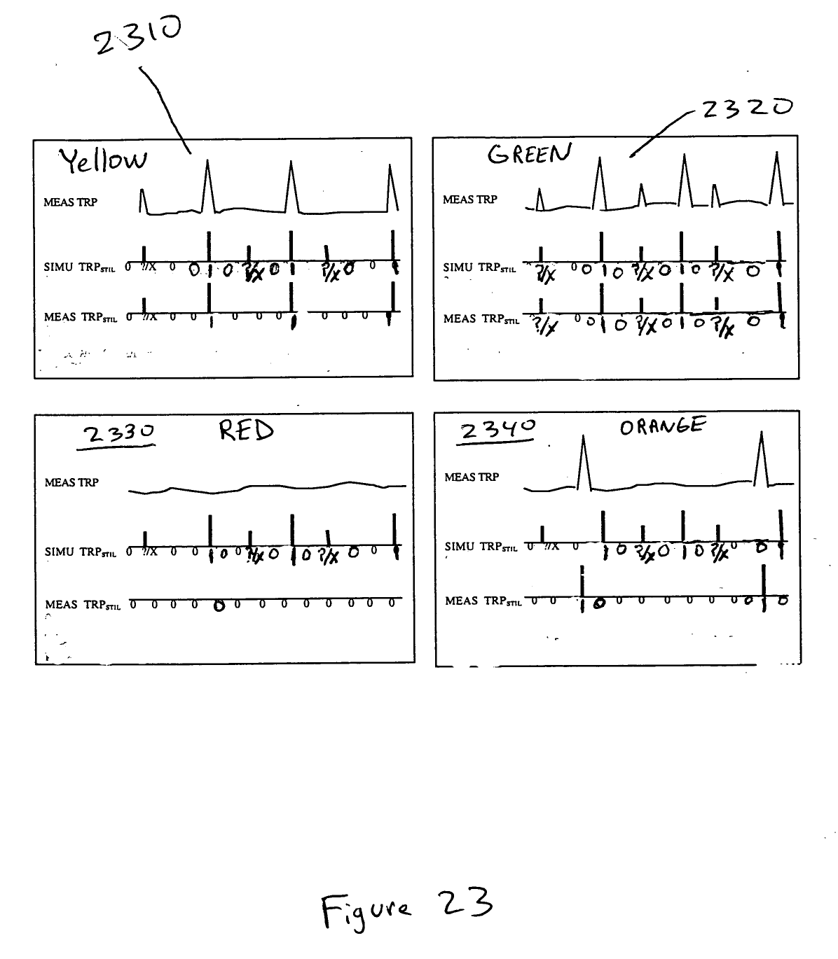

Now, a method for localizing a fault in a circuit (e.g., transistor, logic gates, logic blocks, etc.) that allows quick determination of fault origin in a device by combining logic simulation and optical measurements is presented. Reference is made to FIGS. 22 and 23.

At 2205 of FIG. 22, simulation data 110 (e.g., simulation STIL-formatted data) based on logical states of the circuit at predetermined intervals is generated. Moreover, at 2215, the simulation data 110 is converted into simulation photon emission data 120 (e.g., simulation TRP_{STIL} format data) based on photon emission intensity of the circuit at the predetermined intervals.

Internal photon emission measurement (at 2220) may take several minutes to record a sufficient number of photons to become meaningful. As operating voltages decrease this time is expected to increase. Typically, the photon emission measurement is performed during a test time period. One test time period represents a test cycle. If an additional number of photons are to be measured, the test cycle is repeated as many times as needed.

At 2225, photon emission data 130 measured at 2220 is digitized. Moreover, the digitized photon emission data 140 is converted into measured photon emission data 150 (e.g., measured TRP_{STIL} format data) based on photon emission intensity of the circuit at predetermined intervals.

Continuing, at 2230, the simulation photon emission data 120 is compared with the measured photon emission data 150 to generate a comparison result. At 2235, the comparison result is classified according to predetermined criteria. Further, the classified comparison result is used in the fault localization technique to determine next action in localizing the fault.

To locate quickly defects/faults with TRPE measurement and simulation, a strategy based on partially probed nodes is used. As shown in FIG. 22, a 4 color coded diagnostic (e.g., Red, Orange, Yellow, and Green) has been chosen to guide the fault localization process, at 2235. Red and Orange correspond to detected faults (no commutation indicated by Red at 2255 or a delay problem indicated by Orange at 2250). At 2255, awareness of a major problem is made. At 2250, the next action in localizing the fault is determined to be probing earlier in the propagation flow. At 2240, Green corresponds to the absence of faults (all measured commutations (e.g., measured TRP_{STIL}) matching simulation (e.g., simulation TRP_{STIL}) and expected timing), allowing probing later in the propagation flow. Yellow corresponds to partially matching the measured commutations (e.g., measured TRP_{STIL}) with the simulation (e.g., simulation TRP_{STIL}) but, for at least the acquired peaks, the timing information seems to be correct, but may be incorrect for the missing peaks. At 2245, it is determined that the photon emission measurement time needs to be increased. In the Yellow case, it may be assumed that the missing peaks are also correct, allowing the fault localization process to continue later in the propagation flow, at 2240. If a timing problem (Orange color) is then found, the last Yellow assumption must then be reconsidered. At this time only, a longer acquisition may be done, in order to verify the assumption made about the timing of the missing peak of the last Yellow assumption. FIG. 23 illustrates the Green case 2320, the Yellow case 2310, the Orange case 2340, and the Red case 2330 of the 4 color coded diagnostic described above.

Further, at 2260, it is determined whether the fault has been localized. If not, a new measurement is performed at 2220. Otherwise, the fault localization process is ended at 2265.

To perform the fault localization technique as fast as possible, so as to probe as many points in the shortest amount of time, the following diagnostics questions are addressed:
1. Is Transistor On/Off (Is there a measured signal?)?;
2. Is Functionality validated (Is the data consistent with the logic gate being examined?)?; and
3. Is Delay/timing measurement accurate (Is there an issue here?)?

From the first minutes of measurement acquisition, the first diagnostic question is answerable—Is there a measured signal? If not, it means that the probed transistor is not activated. A major functional fault is associated with this node. Probing nodes located earlier in the propagation flow will identify where the signal started to deteriorate.

If some photon emission is measured, the second diagnostic question concerning the validation of the functional behavior is answerable. Is the number of measured commutations (photon emission peaks) matching the logic simulation? If not, probing earlier in the propagation flow is necessary to isolate the fault site.

The third diagnostic question concerns timing and delay differences between measurement and simulation. If the margin is too great, probing earlier in the propagation flow to determine if the delay is coming from earlier gates is performed. If it is not coming from any earlier gate, the fault is due to an interconnect issue. If the timing of the measurements and simulation match, it means the fault is later in the propagation flow. In an embodiment, the determination of the next point to probe is done by following an extended binary search. With this strategy, at each measurement the number of remaining candidates is halved. If a sample of 512 nodes are potentially linked to a fault, the fault can be located after 8 measurements (2⁸=512).

To speed fault localization, it is not always necessary to wait for a long acquisition to capture all commutations. Assuming the probed transistor is working, upon 2 out of 3 commutations are measured, the acquisition may be stopped. If later in the propagation flow a problem is found, it may be linked to the missing peak and a longer acquisition may then be necessary.

In an embodiment, the method for localizing faults described with respected to FIGS. 22 and 23 can be utilized to localize faults in a plurality of circuits rather than in a single circuit. Here, simulation photon emission data (e.g., simulation TRP_{STIL}) for each circuit is generated. The simulation photon emission data (e.g., simulation TRP_{STIL}) of each circuit is merged into a composite simulation photon emission data. Composite measured photon emission data for the circuits is generated since the plurality of circuits are measured at the same time. The composite simulation photon emission data is compared with the composite measured photon emission data to generate a comparison result. The comparison result is classified according to predetermined criteria. Further, the classified comparison result is used in a fault localization technique to determine next action in localizing the fault.

In an embodiment, the methods of the present invention are performed by computer-executable instructions stored in a computer-readable medium, such as a magnetic disk, CD-ROM, an optical medium, a floppy disk, a flexible disk, a hard disk, a magnetic tape, a RAM, a ROM, a PROM, an EPROM, a flash-EPROM, or any other medium from which a computer can read. The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A method of localizing a fault in a circuit, said method comprising:
generating simulation data based on logical states of said circuit at predetermined intervals;
converting said simulation data into simulation photon emission data based on photon emission intensity of said circuit at said predetermined intervals; and
using said simulation photon emission data in a fault localization technique.

2. The method as recited in claim 1 wherein said simulation photon emission data includes a first state indicating a strong photon emission value, a second state indicating a weak photon emission value, and a third state indicating no photon emission.

3. The method as recited in claim 2 wherein said first state corresponds to a transition from a high logic state to a low logic state, and wherein said second state corresponds to a transition from a low logic state to a high logic state.

4. The method as recited in claim 2 wherein said second state corresponds to a transition from a high logic state to a low logic state, and wherein said first state corresponds to a transition from a low logic state to a high logic state.

5. The method as recited in claim 1 wherein said simulation data is compliant with a Standard Test Interface Language (STIL) format.

6. The method as recited in claim 1 wherein said simulation data is compliant with a Voltage Change Dump (VCD) format.

7. A method of localizing a fault in a circuit, said method comprising:
measuring photon emission from said circuit during a test time period to form photon emission data;
repeating said measurement a plurality of test cycles;
digitizing said photon emission data;
converting said digitized photon emission data into measured photon emission data based on photon emission intensity of said circuit at predetermined intervals; and
using said measured photon emission data in a fault localization technique.

8. The method as recited in claim 7 wherein said measured photon emission data includes a first state indicating a strong photon emission value, a second state indicating a weak photon emission value, and a third state indicating no photon emission.

9. The method as recited in claim 8 wherein said first state corresponds to a transition from a high logic state to a low logic state, and wherein said second state corresponds to a transition from a low logic state to a high logic state.

10. The method as recited in claim 8 wherein said second state corresponds to a transition from a high logic state to a low logic state, and wherein said first state corresponds to a transition from a low logic state to a high logic state.

11. A method of localizing a fault in a circuit, said method comprising:
generating simulation photon emission data for said circuit;
generating measured photon emission data for said circuit;
comparing said simulation photon emission data with said measured photon emission data to generate a comparison result;
classifying said comparison result according to predetermined criteria; and
using said classified comparison result in a fault localization technique to determine next action in localizing said fault.

12. The method as recited in claim 11 wherein said generating simulation photon emission data includes:
generating simulation data based on logical states of said circuit at predetermined intervals; and
converting said simulation data into said simulation photon emission data based on photon emission intensity of said circuit at said predetermined intervals.

13. The method as recited in claim 12 wherein said simulation data is compliant with a Standard Test Interface Language (STIL) format.

14. The method as recited in claim 12 wherein said simulation data is compliant with a Voltage Change Dump (VCD) format.

15. The method as recited in claim 11 wherein said generating measured photon emission data includes:
measuring photon emission from said circuit during a test time period to form photon emission data;
repeating said measurement a plurality of test cycles;
digitizing said photon emission data; and
converting said digitized photon emission data into said measured photon emission data based on photon emission intensity of said circuit at predetermined intervals.

16. The method as recited in claim 11 wherein each of said simulation photon emission data and said measured photon emission data includes a first state indicating a strong photon emission value, a second state indicating a weak photon emission value, and a third state indicating no photon emission.

17. The method as recited in claim 16 wherein said first state corresponds to a transition from a high logic state to a low logic state, and wherein said second state corresponds to a transition from a low logic state to a high logic state.

18. The method as recited in claim 16 wherein said second state corresponds to a transition from a high logic state to a low logic state, and wherein said first state corresponds to a transition from a low logic state to a high logic state.

19. The method as recited in claim 11 wherein said classifying said comparison result includes:
assigning said comparison result one of a plurality of classifications, wherein said classifications include a first classification indicating no photon emission was measured, a second classification indicating said simulation photon emission data matched said measured photon emission data, a third classification indicating said simulation photon emission data partially matched said measured photon emission data, and a fourth classification indicating no match between said simulation photon emission data and said measured photon emission data.

20. The method as recited in claim 11 further comprising:
using said measured photon emission data in a model of said circuit.

21. A method of localizing a fault in a plurality of circuits, said method comprising:
generating simulation photon emission data for each circuit;
merging said simulation photon emission data of each circuit into a composite simulation photon emission data;
generating composite measured photon emission data for said circuits;
comparing said composite simulation photon emission data with said composite measured photon emission data to generate a comparison result;
classifying said comparison result according to predetermined criteria; and
using said classified comparison result in a fault localization technique to determine next action in localizing said fault.

22. The method as recited in claim 21 wherein said generating simulation photon emission data includes:
for each circuit, generating simulation data based on logical states of said circuit at predetermined intervals; and
for each circuit, converting said simulation data into said simulation photon emission data based on photon emission intensity of said circuit at said predetermined intervals.

23. The method as recited in claim 22 wherein said simulation data is compliant with a Standard Test Interface Language (STIL) format.

24. The method as recited in claim 22 wherein said simulation data is compliant with a Voltage Change Dump (VCD) format.

25. The method as recited in claim 21 wherein said generating composite measured photon emission data includes:
measuring photon emission from said circuits during a test time period to form photon emission data;
repeating said measurement a plurality of test cycles;
digitizing said photon emission data; and
converting said digitized photon emission data into said composite measured photon emission data based on photon emission intensity of said circuits at predetermined intervals.

26. The method as recited in claim 21 wherein each of said composite simulation photon emission data and said composite measured photon emission data includes a first state indicating a strong photon emission value, a second state indicating a weak photon emission value, and a third state indicating no photon emission.

27. The method as recited in claim 26 wherein said first state corresponds to a transition from a high logic state to a low logic state, and wherein said second state corresponds to a transition from a low logic state to a high logic state.

28. The method as recited in claim 26 wherein said second state corresponds to a transition from a high logic state to a low logic state, and wherein said first state corresponds to a transition from a low logic state to a high logic state.

29. The method as recited in claim 21 wherein said classifying said comparison result includes:
assigning said comparison result one of a plurality of classifications, wherein said classifications include a first classification indicating no photon emission was measured, a second classification indicating said composite simulation photon emission data matched said composite measured photon emission data, a third classification indicating said composite simulation photon emission data partially matched said composite measured photon emission data, and a fourth classification indicating no match between said composite simulation photon emission data and said composite measured photon emission data.

30. The method as recited in claim 21 further comprising:
using said composite measured photon emission data in a model of said circuits.
